(19) United States
(12) Patent Application Publication
(10) Pub. No.: US 2025/0196996 A1
(43) Pub. Date: Jun. 19, 2025

(54) PROPELLER COMPRISING AT LEAST ONE BLADE HOLDING SYSTEM INCLUDING AT LEAST ONE TRANSVERSE GROOVE

(71) Applicant: Airbus Operations (S.A.S.), Toulouse (FR)

(72) Inventors: Lionel Czapla, Toulouse (FR); Kotaro Fukasaku, Toulouse (FR); Rémi Amargier, Toulouse (FR)

(21) Appl. No.: 18/978,817

(22) Filed: Dec. 12, 2024

(30) Foreign Application Priority Data
Dec. 13, 2023 (FR) 2314104

(51) Int. Cl. B64C 11/06

(52) U.S. Cl. CPC B64C 11/06

(57) ABSTRACT

A propeller includes a hub, blades each provided with a shank, a pivoting connection connecting the shank of the blade and the hub and having a pivot axis and at least one holding system for holding the blade connected to the hub. The holding system is reinforced and includes at least one main stop integral with the hub and configured to be at least partially housed in a transverse groove, provided in a surface integral with the shank of the blade, which extends over at least a part of the circumference of the shank. This solution reduces the risk of blades or blade debris being ejected. An aircraft propulsion assembly includes at least one such propeller.

### TECHNICAL FIELD

The subject matter herein relates to a propeller comprising at least one blade holding system including at least one transverse groove and to an aircraft propulsion assembly including at least one such propeller.

### BACKGROUND

According to an embodiment shown in FIG. 1, an aircraft 10 comprises a fuselage 12, wings 14 arranged on each side of the fuselage, and propulsion assemblies 16 connected to the wings 14.

According to a configuration shown in FIG. 2, an electric propulsion assembly 16 comprises at least one motor 18, a gearbox 20, and a propeller 22 connected to an output shaft 24 of the gearbox 20. The propeller 22 comprises a hub 26 which has a rotation axis A26 and blades 28 each having a first end 28.1, referred to as the shank, connected to the hub 26.

For the remainder of the description, an axial direction is a direction parallel to the rotation axis A26 of the hub 26. A radial direction is a direction perpendicular to the rotation axis A26.

As illustrated in FIG. 3, for each blade 28, the hub 26 comprises a housing 30, delimited by a first lateral surface S30, having an axis of revolution coincident with a radial direction. In addition, the shank 28.1 of the blade 28 is configured to be housed in the housing 30 and has a second lateral surface S28.1 of revolution and an axis of revolution A28.

For a given blade, a longitudinal plane is a plane containing the axis of revolution A28 of the shank 28.1 of the blade 28 and a transverse plane is a plane perpendicular to the axis of revolution A28.

According to one configuration, the blades 28 are variable-pitch blades. To this end, the shank 28.1 of each blade 28 is connected by a pivoting connection 32 to the hub 26, a holding system 34 for holding the blade 28 connected to the hub 26. This pivoting connection 32 comprises several bearings 32.1 interposed between the first and second lateral surfaces S30 and S28.1 of the hub 26 and of the blade 28. The holding system 34 comprises first and second stops 34.1, 34.2 positioned on each side of a set of bearings 32.1, the first stop 34.1 being positioned between the rotation axis A26 of the hub 26 and the set of bearings 32.1.

The first stop 34.1 is a fillet integral with the blade 28, situated on the second lateral surface S28.1 of the shank 28.1 of the blade 28, bearing against one of the bearings 32.1. The second stop 34.2 is a nut positioned between the first and second lateral surfaces S30 and S28.1, bearing against one of the bearings 32.1, configured to be screwed onto a threaded section of the first lateral surface S30 of the housing 30 of the hub 26.

According to this embodiment, in the event of damage to the bearings 32.1 positioned between the first and second stops 34.1, 34.2 of the system 34 for holding the blade 28, the risk of this blade 28 being ejected is relatively high. Consequently, the parts of the aircraft liable to be impacted by the blade 28 or the debris from this blade 28 have to be reinforced, which increases the on-board mass of the aircraft.

### SUMMARY

The disclosure herein is intended to overcome some or all of the drawbacks in the prior art.

To this end, the disclosure herein relates to a propeller comprising a hub, blades each provided with a shank and, for each blade, a connection system connecting the blade and the hub and including:
a. at least one first lateral surface integral with the hub,
b. at least one second lateral surface, integral with the shank of the blade, having a circumference,
c. a pivoting connection having a pivot axis and at least one bearing interposed between the first and second lateral surfaces,
d. at least one holding system for holding the blade connected to the hub.

According to the disclosure herein, the holding system comprises at least one transverse groove in the second lateral surface, which extends over at least a part of the circumference of the second lateral surface, and at least one main stop, integral with the hub, configured to be at least partially housed in the transverse groove.

This solution limits the risk of blades or blade debris being thrown out. This obviates the need to reinforce the zones which were previously liable to be impacted by the blade or blade debris.

According to another feature, each transverse groove extends over the entire circumference of the second lateral surface.

According to another feature, the connection system comprises a sleeve, interposed between the shank of the blade and the bearing(s), having an outer surface in which the transverse groove(s) is (are) provided.

According to another feature, the main stop comprises at least one pin, integral with the hub and oriented perpendicularly to the pivot axis, which extends between first and second ends, the first end being housed in the transverse groove. In addition, the hub comprises, for each pin, an orifice configured to partially house the pin, the orifice having a cross section substantially equal to the cross section of the pin and being oriented perpendicular to the pivot axis.

According to another feature, each pin is configured to occupy a first state in which the first end of the pin is housed in the transverse groove and a second state in which the second end of the pin is withdrawn from the blade and is no longer housed in the transverse groove.

According to another feature, the orifice is a through-hole, the second end of the pin being positioned outside the hub.

According to another feature, the pin comprises at least one threaded section configured to cooperate with a threaded section of the orifice.

According to another feature, the holding system comprises a lock nut configured to be screwed onto the pin and to be in contact with the hub.

According to another feature, the holding system comprises a flexible link connecting the second end of the pin and the hub.

According to another feature, the pin and the transverse groove are positioned between the bearing(s) and a rotation axis of the hub.

According to another feature, the holding system comprises at least one secondary stop chosen from a fillet, a shoulder, an elastic ring integral with the blade and/or a nut or an elastic ring integral with the hub.

The disclosure herein also relates to an aircraft propulsion assembly comprising at least one propeller according to one of the preceding features.

### BRIEF DESCRIPTION OF THE DRAWINGS

Other features and advantages are set out in the description of the disclosure herein below, given purely by way of example and with reference to the attached drawings, in which:

FIG. 1 is a side view of an aircraft;

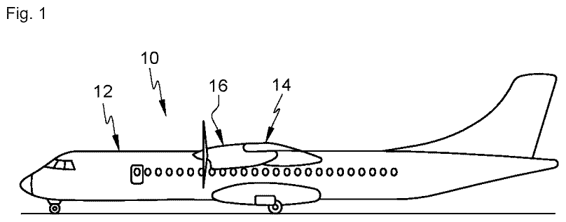

FIG. 2 is a side view of a propulsion assembly of an aircraft;

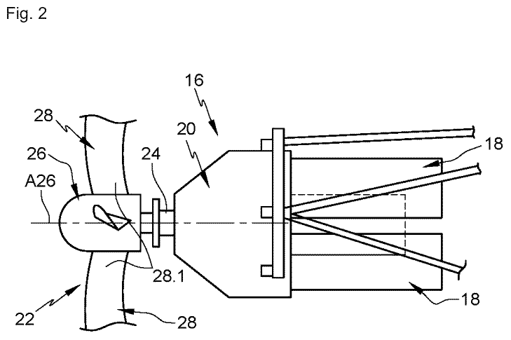

FIG. 3 is a longitudinal section of a connection system connecting a blade and a hub of a propeller, illustrating an embodiment of the prior art;

FIG. 4 is a longitudinal section of a connection system connecting a blade and a hub of a propeller, illustrating an embodiment of the disclosure herein;

FIG. 5 is a longitudinal section of a part of a connection system connecting a blade and a hub of a propeller, illustrating another embodiment of the disclosure herein; and

FIG. 6 is a perspective view of the blade shank shown in FIG. 5.

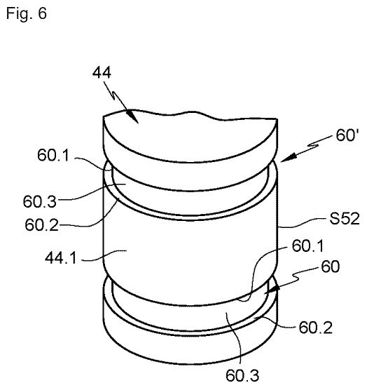

### DETAILED DESCRIPTION

A propeller 40 comprises a hub 42 which has a rotation axis and blades 44 which each have a shank 44.1 connected to the hub 42 by a connection system 46.

According to a non-limiting application, an aircraft comprises at least one propulsion assembly including at least one such propeller 40. This propulsion assembly may be an electric propulsion assembly or a turboprop propulsion assembly.

The blades 44 are variable-pitch blades. To this end, for each blade 44, the connection system 46 comprises the shank 44.1 of the blade 44, a housing 48 integral with the hub 42 and configured to receive the shank 44.1 of the blade 44, and a pivoting connection 50, connecting the shank 44.1 of the blade 44 and the hub 42, which has a pivot axis A50.

According to an embodiment, the housing 48 of the hub 42 comprises a first lateral surface S48 having an axis of revolution coincident with the pivot axis A50 when the blade 44 is connected to the hub 42. In addition, the shank 44.1 of the blade 44 comprises a second lateral surface S52 having an axis of revolution coincident with the pivot axis A50 when the blade 44 is connected to the hub 42.

The pivoting connection 50 comprises at least one bearing 54 interposed between the first and second lateral surfaces S48, S52 and configured to allow the shank 44.1 of the blade 44 to pivot about the pivot axis A50 with respect to the hub 42. According to one configuration, the pivoting connection 50 comprises several bearings 54 that are interposed between the first and second lateral surfaces S48, S52 and offset with respect to each other in a direction parallel to the pivot axis A50.

According to a configuration, each bearing 54 has an internal diameter substantially equal to the external diameter of the second lateral surface S52 of the shank 44.1 and an external diameter substantially equal to the internal diameter of the first surface S48.

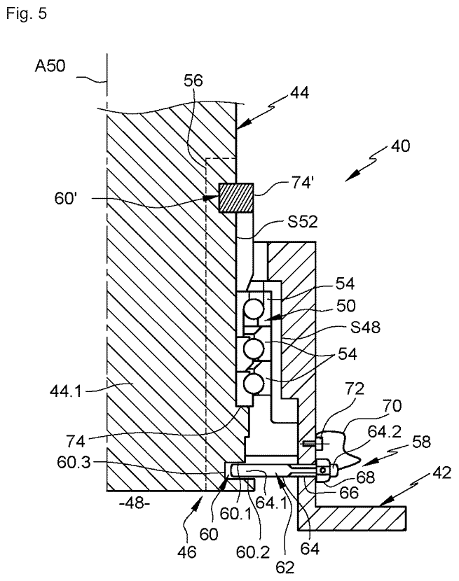

Whatever the embodiment, the connection system 46 comprises at least one first lateral surface S48 integral with the hub 42, at least one second lateral surface S52 integral with the shank 44.1 of the blade 44, and a pivoting connection 50 which has a pivot axis A50 and at least one bearing 54 interposed between the first and second lateral surfaces S48, S52. The first lateral surface S48 may be the lateral surface of the hub 42 or of any other part integral with the hub 42 and interposed between the latter and the bearing(s) 54. The second lateral surface S52 may be the lateral surface of the shank 44.1 of the blade 44 or of any other part integral with the blade 44 and interposed between the latter and the bearing(s) 54. Thus, as illustrated in dashed lines in FIG. 5, the connection system 46 may comprise a sleeve 56 that is interposed between the shank 44.1 of the blade 44 and the bearing(s) 54, is constrained at least to rotate with the shank 44.1 of the blade 44, and that has an outer surface which forms the second lateral surface S52, in contact with the bearing(s) 54 and oriented towards the first lateral surface S48 integral with the hub 42.

The connection system 46 comprises at least one holding system 58 for holding the blade 44 connected to the hub 42. This holding system 58 includes at least one transverse groove 60 in the second lateral surface S52, which extends over at least a part of the circumference of the second lateral surface S52, and at least one main stop 62, integral with the hub 42, configured to be at least partially housed in the transverse groove 60 so as to immobilize the blade 44 with respect to the hub 42 in the longitudinal direction (parallel to the pivot axis A50) and to allow the blade 44 to pivot with respect to the hub 42 about the pivot axis A50.

According to an embodiment, each transverse groove 60 extends over the entire circumference of the second lateral surface S52.

Each transverse groove 60 comprises a first annular edge 60.1 positioned in a first transverse plane perpendicular to the pivot axis A50, a second annular edge 60.2 positioned in a second transverse plane perpendicular to the pivot axis A50, and a bottom 60.3, which connects the first and second annular edges 60.1, 60.2, and is cylindrical and coaxial to the pivot axis A50. Each transverse groove 60 has a given width (dimension measured in the longitudinal direction between the first and second annular edges 60.1, 60.2).

According to an embodiment, the transverse groove 60 is provided in the outer surface of the sleeve 56 forming the second lateral surface S52. Thus, the blade 44 can be made of a composite material and the sleeve 56 can be made of another material, for example metal.

According to an arrangement, the holding system 58 comprises first and second transverse grooves 60, 60′ positioned on each side of the bearing(s) 54, the first transverse groove 60 being offset towards the rotation axis of the hub 42 with respect to the bearing(s) 54.

According to an embodiment, the main stop 62 comprises at least one pin 64, integral with the hub 42 and oriented perpendicularly to the pivot axis A50, which extends between first and second ends 64.1, 64.2, the first end 64.1 being housed in the transverse groove 60, between the first and second annular edges 60.1, 60.2. The pin 64 (and more particularly the first end 64.1 thereof) has a cross section equal to or very slightly smaller than the width of the transverse groove 60 in which the first end 64.1 is housed.

According to a configuration, each pin 64 is configured to occupy a first state in which the first end 64.1 of the pin 64 is housed in the transverse groove 60 and a second state in which the second end 64.1 of the pin 64 is withdrawn from the blade 44 and is no longer housed in the transverse groove 60. In this second state, the blade 44 can be removed.

According to one configuration, the pin 64 is cylindrical. In addition, the hub 42 comprises, for each pin 64, an orifice 66 configured to partially house the pin 64, the orifice 66 having a cross section substantially equal to the cross section of the pin and being oriented perpendicular to the pivot axis A50.

According to one arrangement, the orifice 66 is a through-hole. In addition, the second end 64.2 of the pin 64 is positioned outside the hub 42 so as to be easily accessible and to enable the pin 64 to be inserted or removed.

According to an embodiment, the pin 64 comprises at least one threaded section configured to cooperate with a threaded section of the orifice 66. In order to prevent the pin 64 from unscrewing, the holding system 58 comprises a lock nut 68 configured to be screwed onto the pin 64 and to be in contact with the hub 42. This enables the pin 64 to be positioned in the first or second state by screwing or unscrewing it.

According to a configuration, the holding system 58 comprises a flexible link 70 connecting the pin 64, and more particularly the second end 64.2 thereof, and the hub 42, and more particularly a screw 72 screwed into a threaded hole provided in the hub 42. This configuration keeps the pin 64 connected to the hub 42 when it is removed.

According to an arrangement, the main stop 62 comprises a single pin 64. In a variant, the main stop 62 comprises several pins 64, cooperating with the same transverse groove 60, distributed about the pivot axis A50.

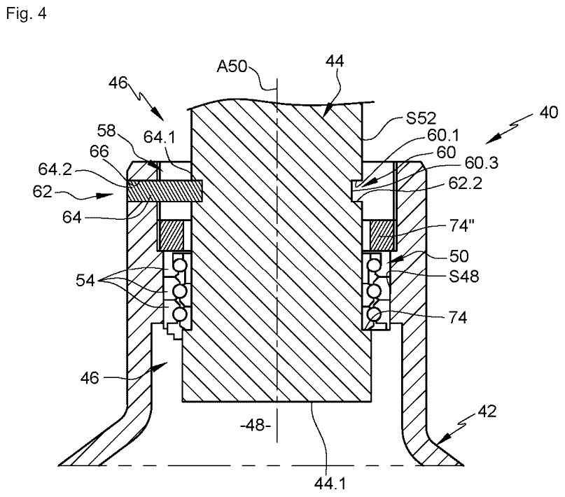

According to a configuration shown in FIG. 4, the pin 64 and the transverse groove 60 are further away than the bearings 54 from the rotation axis of the hub 42.

According to another configuration shown in FIG. 5, the pin 64 and the transverse groove 60 are positioned between the bearings 54 and the rotation axis of the hub 42. To this end, the shank 44.1 of the blade 44 comprises an extension which extends beyond the bearings 54 towards the rotation axis of the hub 42.

Of course, the disclosure herein is not limited to these embodiments for the main stop 62. Whatever the embodiment, the main stop 62 is integral with the hub 42 and has a part housed in the transverse groove 60 to immobilize the blade 44 with respect to the hub 42 in the longitudinal direction (parallel to the pivot axis A50). The holding system 58 limits the risk of blades or blade debris being thrown out. This obviates the need to reinforce the zones which were previously liable to be impacted by the blade or blade debris.

The holding system 58 may comprise at least one secondary stop 74, 74′, 74″ to limit the movements of the blade 44 with respect to the hub 42 in the longitudinal direction (parallel to the pivot axis A50), chosen from a fillet, a shoulder, an elastic ring integral with the blade 44 and/or a nut or an elastic ring integral with the hub 42.

According to an embodiment shown in FIG. 5, the holding system 58 comprises a first secondary stop 74 in the form of a fillet or a shoulder provided on the second lateral surface S52 and/or a second secondary stop 74′ in the form of an elastic ring partially housed in a transverse groove 60′ provided in the second lateral surface S52, the first and second secondary stops 74, 74′ being positioned on each side of the bearings 54.

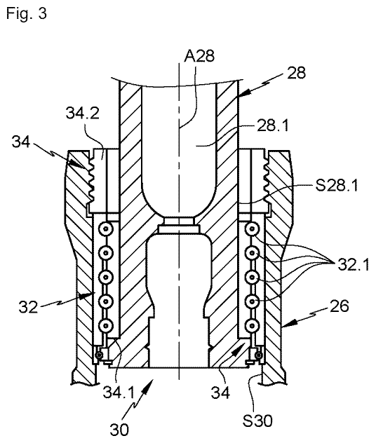

According to another embodiment shown in FIG. 3, the holding system 58 comprises a first secondary stop 74 in the form of a fillet or a shoulder provided on the second lateral surface S52 and/or a second secondary stop 74″ in the form of a nut configured to be screwed onto a threaded section of the first lateral surface S48 of the housing 48, the first and second secondary stops 74, 74″ being positioned on each side of the bearings 54.

Of course, the disclosure herein is not limited to these embodiments for the secondary stops 74, 74′, 74″. These secondary stops reinforce the capacity of the holding system 58 to hold the blade 44 connected to the hub 42.

According to a first configuration, the transverse groove 60 and the main stop 62 are fitted together (with no clearance in the longitudinal direction between the transverse groove 60 and the main stop 62). In this case, the transverse groove 60 and the main stop 62 help to hold the blade 44 in the normal configuration, providing an additional solution for transferring the loads from the blade 44 to the hub 42 in addition to a holding system in the prior art for example including at least one of the following elements: a bearing, a stop or a nut.

According to a second configuration, the holding system 58 has a clearance in the longitudinal direction between the transverse groove 60 and the main stop 62. In this case, the transverse groove 60 and the main stop 62 offer a standby solution for transferring the loads from the blade 44 to the hub 42. This standby solution becomes active in the event of rupture of the holding system in the prior art for example including at least one of the following elements: a bearing, a stop or a nut.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propeller comprising a hub, blades each comprising a shank and, for each blade, a connection system connecting the blade and the hub and comprising:
at least one first lateral surface integral with the hub;
at least one second lateral surface, integral with the shank of the blade, having a circumference;
a pivoting connection having a pivot axis and at least one bearing interposed between the first and second lateral surfaces;
at least one holding system for holding the blade connected to the hub; wherein the holding system comprises at least one transverse groove in the second lateral surface, which extends over at least a part of the circumference of the second lateral surface, and at least one main stop, integral with the hub, configured to be at least partially housed in the transverse groove.

2. The propeller according to claim 1, wherein each transverse groove extends over an entire circumference of the second lateral surface.

3. The propeller according to claim 1, wherein the connection system comprises a sleeve, interposed between the shank of the blade and the bearing, having an outer surface in which the transverse groove is provided.

4. The propeller according to claim 1, wherein the main stop comprises at least one pin, integral with the hub and oriented perpendicularly to the pivot axis, which extends between first and second ends, the first end being housed in the transverse groove, and wherein the hub comprises, for each pin, an orifice configured to partially house the pin, the orifice having a cross section substantially equal to a cross section of the pin and being oriented perpendicular to the pivot axis.

5. The propeller according to claim 1, wherein each pin is configured to occupy a first state in which the first end of the pin is housed in the transverse groove and a second state in which the second end of the pin is withdrawn from the blade and is no longer housed in the transverse groove.

6. The propeller according to claim 4, wherein the orifice is a through-hole, the second end of the pin being positioned outside the hub.

7. The propeller according to claim 6, wherein the pin comprises at least one threaded section configured to cooperate with a threaded section of the orifice.

8. The propeller according to claim 7, wherein the holding system comprises a lock nut configured to be screwed onto the pin and to be in contact with the hub.

9. The propeller according to claim 6, wherein the holding system comprises a flexible link connecting the second end of the pin and the hub.

10. The propeller according to claim 4, wherein the pin and the transverse groove are positioned between the bearing and a rotation axis of the hub.

11. The propeller according to claim 1, wherein the holding system comprises at least one secondary stop that comprises a fillet, a shoulder, an elastic ring integral with the blade and/or a nut or an elastic ring integral with the hub.

12. An aircraft propulsion assembly comprising at least one propeller according to claim 1.
